(19) United States
(12) Patent Application Publication
(10) Pub. No.: US 2008/0047885 A1
(43) Pub. Date: Feb. 28, 2008

(54) Filter Cleaning Head

(75) Inventor: Ruben Shiekelmacher, Korazim (IL)

Correspondence Address: NATH & ASSOCIATES, 112 South West Street, Alexandria, VA, 22314, US

(73) Assignee: Amiad Filtration Systems

(21) Appl. No.: 11/658,033

(22) PCT Filed: Dec. 23, 2004
(86) PCT No.: PCT/IL04/01162

§ 371 Date: Jan. 22, 2007

(30) Foreign Application Priority Data
Jul. 21, 2004 (IL) 163126

(51) Int. Cl. B01D 29/23; B01D 29/68

(52) U.S. Cl. 210/107

(57) ABSTRACT

A filtering device has a filter element disposed between the inlet and the outlet of the device. The inlet surface of the filter element is prone to clogging by suspended particles, e.g. waste, carried with the incoming raw fluid. The invention provides a cleaning head for the filtering device, comprising a basis and a nozzle movably mounted thereon. The cleaning head basis is mounted on a driving mechanism so that the nozzle can scan the inlet surface parallel thereto, and can clean the inlet surface by means of a backwash flow passing through the filter element into the nozzle under a cleaning pressure differential created by connecting the nozzle to a low-pressure outlet. The nozzle maintains, during scanning, permanent contact with the inlet surface so that lateral flow directly into the nozzle is essentially prevented despite variations of distance between the cleaning head basis and the inlet surface during the scanning.

### FIELD OF THE INVENTION

This invention relates to self-cleaning and manually cleaned filters, in particular to filters using a suction head to clean clogged surface of a filter element.

### BACKGROUND OF THE INVENTION

GB 1485989 discloses a filter with an outward-flow cylindrical filter element which is cleaned by three axially and angularly spaced rotary nozzles. The nozzles are axially elongated and spring-loaded into contact with the inner surface of the filter element. They are connected by a central duct to a solids discharge valve, which opens to atmosphere so that the pressure outside the element causes reverse flow through the filter element opposite the nozzles. The duct is rotated by a motor so that the three nozzles sweep axially overlapping sections of the filter element. Nozzles are spring-loaded at each axial end or in their middle and are movable in radial direction. Each nozzle comprises a cloth-reinforced phenolic resin pad which engages the internal wall of the filter element and may be independently spring-loaded.

GB2157964 describes a filter with a cylindrical filter body and a device for backwashing the filter body by reverse flow of the filtered fluid, positioned within the filter body. The device includes a rotary coaxial backwash duct for removal of the backwashing fluid and a few backwash heads (nozzles) pivoted by pins to the backwash duct. The backwash heads are elongated parallel to the filter axis and the pins are also parallel to the filter axis. The heads are biased into engagement with the filter body such that, upon rotary movement of the backwash duct, the heads sweep the filter body, the pivotal mounting absorbing irregularities in surface contour.

U.S. Pat. No. 4,042,504 discloses a number of self-cleanable filters with cylinder filter body and a cleaning body (nozzle) movable along the cylindrical surface of the filter body for cleaning same by suction. In some of the embodiments, the cleaning body is mounted for both linear and rotary movements, resulting in scanning the filter body along a helical path.

### SUMMARY OF THE INVENTION

A filtering device has an inlet for raw fluid coming under high operative pressure, an outlet for filtered fluid, and a filter element disposed between the inlet and the outlet. The inlet is in fluid communication with an inlet chamber bounded by an inlet surface of the filter element and the inlet surface is prone to clogging by suspended particles, e.g. waste, carried with the incoming raw fluid.

In accordance with the present invention, there is provided a cleaning head for the above filtering device. The cleaning head comprises a basis and a nozzle movably mounted thereon. The nozzle has an orifice defined in a rim, the orifice being connectable to a low-pressure outlet. The cleaning head basis is mountable on a driving mechanism so that the nozzle can scan the inlet surface parallel thereto, and can clean the inlet surface by means of a backwash flow passing through the filter element into the orifice under a cleaning pressure differential created by connecting the orifice to the low-pressure outlet.

The orifice is compact, with largest dimension at least an order of magnitude less than any dimension of the filter element along the inlet surface, and the nozzle is movable to maintain, during scanning, permanent contact between the rim and the inlet surface so that lateral flow from the inlet chamber directly into the orifice is essentially prevented despite variations of distance between the cleaning head basis and the inlet surface during the scanning.

The nozzle may be mounted to the cleaning head basis by a moveable joint allowing perpendicular movement of the nozzle with respect to the inlet surface in order to maintain the permanent contact. Preferably, the moveable joint comprises a biasing means urging the nozzle to the inlet surface.

The moveable joint and the biasing means allow the perpendicular movement of the nozzle within a first range of distance relative to the cleaning head basis; the filter element has deviations of the inlet surface within a second range of distance relative to the cleaning head basis. Preferably, the second range, during the scanning, is substantially within the first range. More preferably, the middle of the second range is substantially in the middle of the first range.

Preferably, the moveable joint of the cleaning head is isolated from the suspended particles in the raw fluid and in the backwash flow.

In an embodiment of the cleaning head, the moveable joint is a telescope joint connecting the nozzle to the head basis. The biasing means may be one or more springs, preferably a cylindrical compression spring coaxial with the telescope joint. The spring preferably is preloaded.

The telescope joint is preferably isolated by at least one sealing ring tightly and firmly mounted on the head basis and tightly sliding along the nozzle. The telescope joint further may comprise at least one annular wiper mounted on the head basis so as to wipe a portion of the nozzle surface that slides past the sealing ring. The annular wiper may be integral with the sealing ring.

Alternatively, the telescope joint may be isolated by at least one elastic sleeve with one end tightly mounted on the head basis and with the other end tightly mounted on the moveable nozzle.

Preferably, the orifice rim has contact surface less than 9 times orifice area, more preferably less than 4 times the orifice area. Preferably, the orifice has a substantially round form defined by an annular rim.

In one embodiment of the cleaning head, the filter element has the shape of a cylinder with the inlet chamber inside, and the driving mechanism provides the scanning of said inlet surface along a helical path parallel to the inlet surface.

The usage of a nozzle that both has a compact orifice and is biased towards the filter element surface allows optimization of the suction process. The compact orifice concentrates the available pressure differential on a small area for effective suction, while the biased nozzle maintains permanent contact with the filter element surface preventing parasite side flow. The biasing force is selected so that the contact friction and wear are limited. The orifice rim may be made with reduced width, further reducing the forces acting between the rim and the filter element. The inventive nozzle allows operation with cleaning pressure differential much higher than the pressure differential, achievable with prior art nozzles.

Glossary:

Cleaning pressure differential: the pressure difference between the exit (outlet) side of the filter element (higher pressure during flushing) and the inlet side of the filter element in front of the cleaning head orifice (lower pressure during flushing).

Contact area: the maximal area of the orifice rim that may contact the inlet surface of the filter element

Dimensions of the filter element: in the case of multiple nozzles used in one filter, these are dimensions of a section of the filter element scanned by a particular nozzle.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a scheme of a filter with cylindrical filtering element and cleaning heads of the present invention;

FIG. 2A is a sectional elevation of the cleaning head of FIG. 1, in design operative position;

FIGS. 2B and 2C are sectional elevations of the cleaning head of FIG. 1, in two extreme operative positions;

FIG. 3A illustrates schematically the operation of a nozzle with wide rim and a gap, known from the prior art.

FIG. 3B illustrates schematically the operation of the nozzle of the present invention, in permanent contact with the filter element.

FIG. 3C illustrates schematically the operation of the nozzle of FIG. 3B but with a narrow rim.

### DETAILED DESCRIPTION OF THE INVENTION

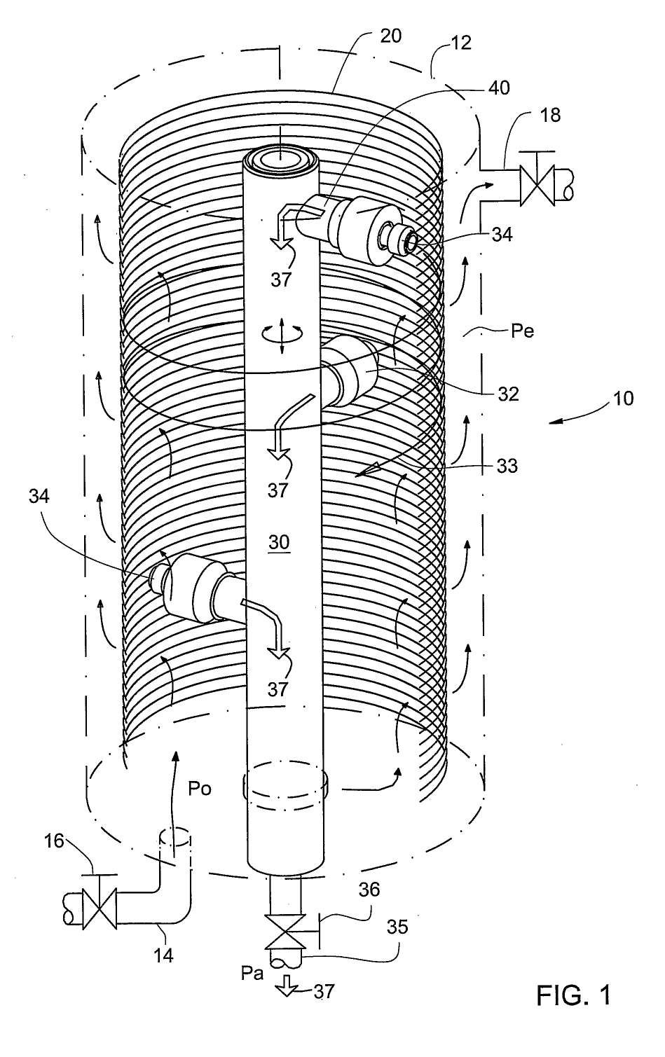

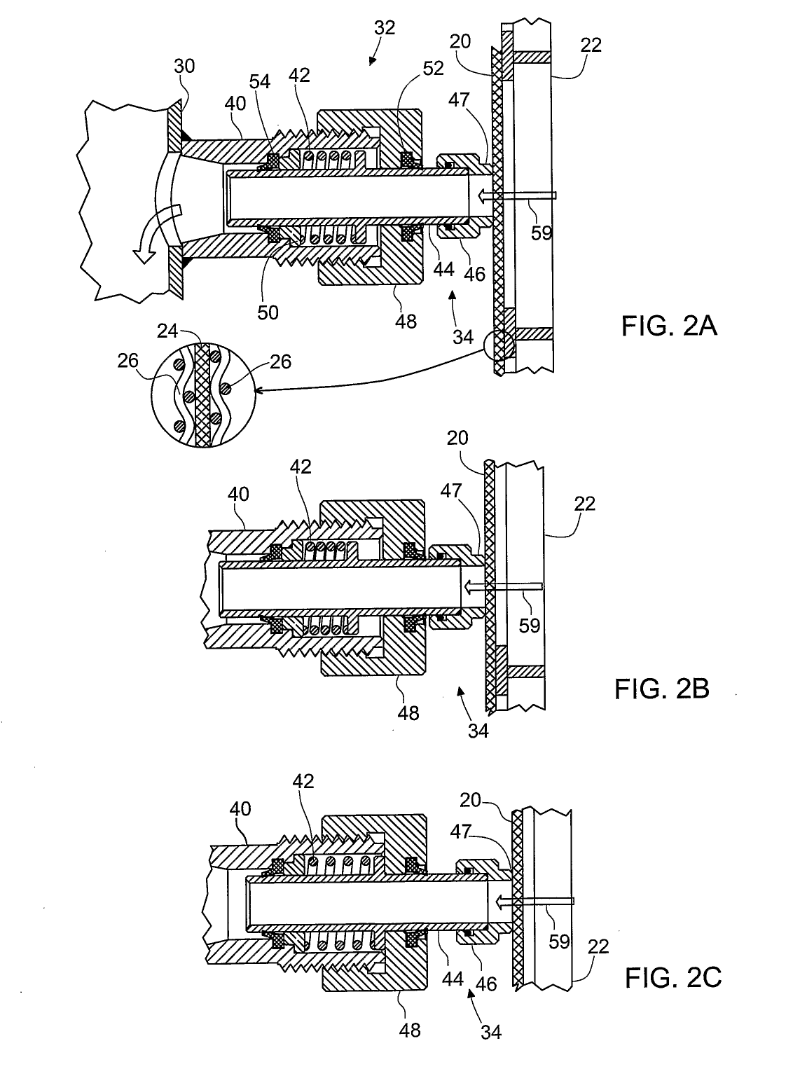

With reference to FIG. 1, there is shown schematically a filter 10, e.g. for filtering irrigation water, comprising a housing 12 with an inlet port 14, an inlet stop valve 16, an outlet port 18, and a filtering element, e.g. mesh 20. The mesh 20 has the form of a straight circular cylinder and is supported from the outer side by a carrying skeletal structure 22 (shown in FIGS. 2A-2C). The mesh 20 may comprise layers of a fine soft mesh 24 supported from one or both sides by a rigid and coarser grid 26.

A rotary pipe 30 with radial cleaning heads 32, each head having a carrying basis 40 and a movable nozzle 34, is mounted coaxially with the filter mesh 20. The pipe 30 is supported in the housing 12 also for axial translation so that a driving system (not shown) can both rotate and translate the pipe. By virtue of the rotation and translation movement, the cleaning heads 32 can scan the inlet (internal) surface of the mesh 20 along a helical line 33, parallel to the inlet surface. The rotary pipe 30 has a discharge outlet 35 with flushing valve 36 which is normally closed.

During normal filtering operation, raw water enters the filter 10 through the inlet port 14 under operative pressure Po and passes through the filtering mesh 20 from inside out. Filtered water leaves the filter under exit pressure Pe through the outlet port 18. In the process, suspended particles are deposited on the inlet surface of the mesh and gradually clog the filter element. The pressure drop across the filter ΔPf=Po−Pe rises and, at some predetermined value ΔPb called “blockage pressure” and detected by an operator or an automatic controller, the filter performs a cleaning operation.

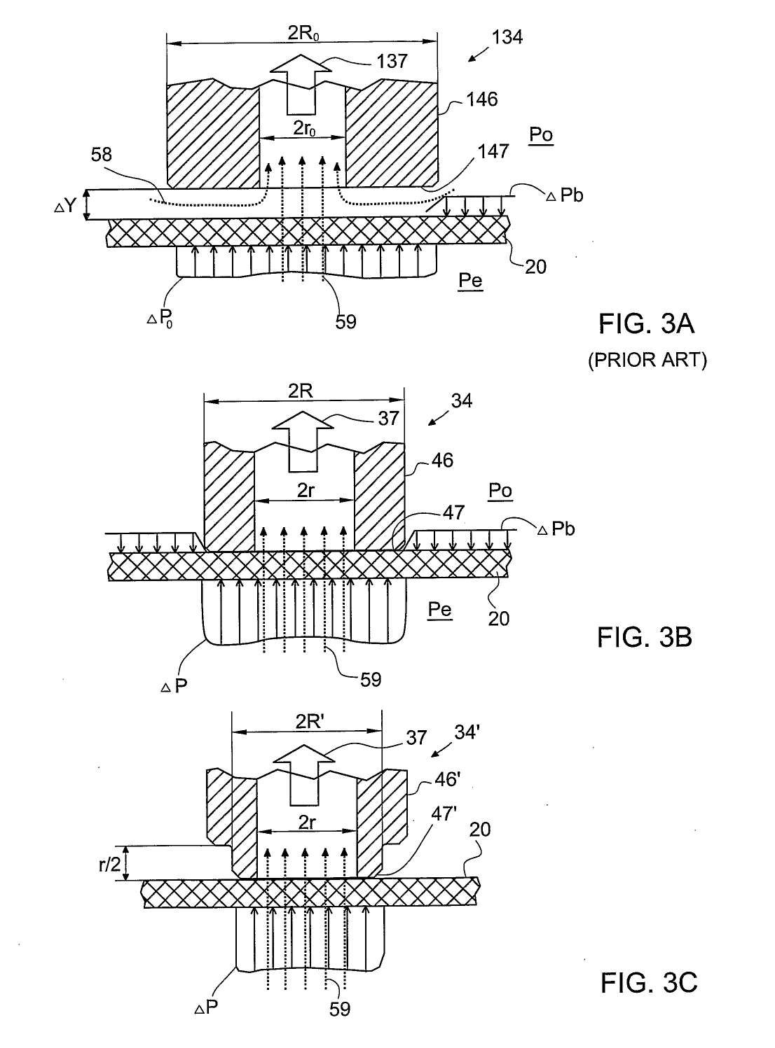

At the start of the cleaning operation, the flushing valve 36 is opened to the atmosphere or to a low-pressure enclosure. The driving system starts to rotate and translate the pipe 30 so that the nozzles 34 scan the inlet surface of the mesh 20. As the pressure at the outlet side of the mesh is higher than the atmospheric pressure Pa, a pressure differential ΔP is established across the mesh in the area opposite the nozzle 34, directed from the mesh to the discharge port 35 (see also FIG. 3B). ΔP is the cleaning pressure differential. The nozzles 34 start to suck the waste material deposited on the inlet surface of the mesh 20 and to dump it by a backwash flow 37 via the pipe 30 and the port 35 out of the filter. Each cleaning head 32 scans a section of the mesh 20 in close turns of the helical path 33 so that the entire surface of the mesh is cleaned up.

The structure and the advantages of the cleaning head of the present invention will become clearer from the sectional elevations shown in FIGS. 2A-2C. With reference to FIG. 2A, the cleaning head 32 includes the tubular head basis 40 which is mounted radially, e.g. welded, to the rotary pipe 30. The head base 40 accommodates the movable nozzle 34 and a cylindrical compression spring 42. The nozzle 34 comprises a nozzle pipe 44 and nozzle cap 46 with an annular rim 47. The tubular basis 40 is closed by a cover 48. The nozzle pipe 44 is supported in the tubular basis 40 by an annular guide 50 and an opening in the cover 48 so as to form an axially movable telescope joint. The cylinder spring 42 urges the nozzle pipe 44 axially towards the inlet surface of the mesh 20. (Note: the direction along the nozzle axis is “radial” direction for the cylinder mesh 20 and the rotary pipe 30).

The shape of the cylinder mesh 20 always deviates from the perfect shape of a geometrical cylinder coaxial with the axis of rotation of the rotary pipe 30, so that the distance between the basis 40 of the cleaning head and the mesh 20 varies during the scanning. The variation may be due to deviations of the carrying structure 22, deviations of the mesh shape, inaccurate mounting of the driving mechanism with respect to the cylinder mesh, etc. FIG. 2B shows the extreme proximal position of the mesh to the cleaning head basis while FIG. 2C shows the extreme distal position of the mesh. The design operative position of the cleaning head 32 is shown in FIG. 2A where the spring biased nozzle 34 is in the middle between the two extreme positions, with ability to move towards either extreme position. The spring 42 maintains the nozzle 34 always in contact with the mesh 20, following the deviations of the mesh shape, so that the gap between the rim 47 and the mesh 20 is virtually closed.

It will be appreciated that the range of available motion of the nozzle perpendicular to the mesh surface must encompass the range of deviation of the mesh surface including mesh and filter structure tolerances, in order to maintain permanent contact and closed gap. The tolerances of the filter structure and the filter element are usually known beforehand and the nozzle motion range is designed to cover them. Preferably, the middle point of the motion range is in the middle of the tolerance range.

The spring 42 is relatively weak in order to maintain low contact pressure on the mesh and to prevent excessive friction force, but it is strong enough to resist significant displacement of the nozzle together with the mesh under the action of the cleaning pressure differential ΔP. For this reason, it is important to protect the telescope joint and the spring from sticking with dirt. Thus, the telescope joint and the spring 42 are protected from the harmful particles by two tight sealing rings 52 and 54 mounted in the cover 48 and in the tubular basis 40 and sliding over the nozzle pipe 44. The sealing rings have also annular lips (wipers) which prevent sticking of particles to the nozzle pipe surface before it enters the annular guides 50 and the sealed chamber.

The advantage of the cleaning action in permanent but gentle contact with the mesh is seen with reference to FIGS. 3A to 3C. In these figures, the cleaning pressure differential ΔP or ΔP₀ acting on the filter element during cleaning is plotted on the exit surface of the filter element.

FIG. 3A shows a nozzle 134 known in the prior art, without biasing means to urge it to the mesh surface. As the nozzle 134 scans the surface of the mesh 20, during a substantial part of the scanning path the nozzle cap 146 is offset from the surface of the mesh 20 by a gap ΔY. The backwash flow 137 in this case comprises a side component 58 and a central component 59. The central component 59 passes through the mesh 20 and is effective for cleaning it, while the side component 58 is wasted without contribution to cleaning. It will be appreciated also that if the gap ΔY between the nozzle rim 147 and the mesh 20 is large, the cleaning pressure differential ΔP₀ across the mesh is lower. For example, if the nozzle orifice is round and has radius r₀, a gap of width r₀/2 will reduce ΔP₀ to none.

The side component may be reduced by using a nozzle with thick walls (thick rim) 147 so that the side flow 58 through the gap would experience greater hydraulic resistance. However, then the force urging the filter element to the nozzle rim 147 will reach high values. This force is approximately the product of the pressure differential ΔP₀ and the nozzle area πR₀² including the orifice area and the rim contact area. If higher pressure differential ΔP₀ is applied, this force may be considerable and capable of bending the filter element towards the nozzle when it moves on to scan further the filter element. In addition to the friction wear, the filter element will be fatigued due to the cyclic bending deformation. This would prevent the usage of higher cleaning pressure differentials.

As shown in FIG. 3B, the nozzle 47 of the present invention is in permanent but gentle contact with the filter element 20 due to the adjustment action of the biasing spring 42. Due to the permanent contact, the side flow 59 is virtually non-existent and the backwash flow 37 consists only of the central flow component 59 which cleans the filter element. The width of the nozzle cap 46 may be made smaller, preferably such that the rim contact area does not exceed 9 times the orifice area, and thus the force of the loaded spring 42 urging the filter element to the nozzle rim 47 may be reduced.

The applied cleaning pressure differential ΔP should be a few times higher than the “blockage pressure” ΔPb in order to remove reliably all particles retained on the filter element. Such high cleaning pressure differential would create strong flow through the nozzle, with specific flow rate an order of magnitude higher than the specific flow through the filter element during normal filtration. Such flow is unattainable with known nozzles having large orifice area, e.g. nozzles extended parallel to the filter element axis. The inventive nozzle is very compact and allows to concentrate the cleaning flow through a limited area of the filter element and to work with cleaning pressure differential which is at least 3 times higher that cleaning pressure differentials used in known filters at a given operative pressure.

A typical irrigation filter works under operative pressure Po between 2 and 10 bar at its inlet. The pressure differential across the filter element ΔPf depends on the flow rate, on the mesh geometry and on the degree of contamination. In the process of operation, ΔPf reaches the “blockage pressure” value ΔPb which is usually about 0.5 bar. Thus the exit pressure Pe=Po−ΔPb before the cleaning action is about 1.5-9.5 bar. When the flushing valve is opened to connect the nozzle to the atmosphere (reference pressure Pa=0), the total pressure differential ΔPt between the exit side of the filter element and the flushing valve outlet will be ΔPt=Pe−Pa≅Pe. The inventive “following” nozzle allows ΔPt to be used almost entirely for cleaning as the nozzle prevents side flow from the inlet chamber directly into the orifice. The inventors have established that the achieved cleaning pressure differential ΔP may be above 80% of the total differential ΔPt. It will be appreciated that the total differential cannot be entirely utilized for cleaning in principle, because of inevitable hydraulic losses in the flow path from the orifice to the atmosphere (in the piping, the flushing valve, etc.). When the operative pressure Po is low, the filtration may be stopped during flushing, e.g. by closing the outlet port 18. Thus the exit pressure Pe may be raised to equal the operative pressure Po, and the cleaning pressure differential ΔP will be raised as well.

With reference to FIG. 3C, the rim width of a nozzle 34′ of the present invention may be further reduced by forming the nozzle cap face with a step, such that the height of step is at least half the orifice radius, and the rim area does not exceed 4 times the orifice area. Thus the force urging the filter element to the nozzle rim may be further reduced as well as the accompanying wear.

The nozzle cap 46′ and the rim 47′ are made of material providing low friction and low friction wear, so that the filter element surface and the nozzle cap 46′ will properly function at least during a filter life time.

The cleaning head of the present invention achieves efficient cleaning of the filtering element (mesh) and reliable prolonged operation under high cleaning pressure. The compact (e.g. round) nozzle orifice concentrates the total available pressure differential on a small area for effective suction. At that, the spring-biased nozzle maintains permanent contact with the filter element surface and limits the friction, mesh deformation and wear. The telescope joint and the spring element between the nozzle and the head basis are protected from contamination and sticking, which allows the usage of weak spring element and further reduction of contact wear. The rim with reduced width also helps to reduce the forces acting between the nozzle rim and the filtering element.

Although a description of specific embodiments has been presented, it is contemplated that various changes could be made without deviating from the scope of the present invention. For example, the present invention could be modified and used for cleaning filter elements with different layouts, such as flat, conical, from inside or from outside of curved filter elements, etc. by using suitable drives for the scanning motion; in mesh filters and in disk filters; the joint of the nozzle may be other than telescope and may be protected by other means, i.e. a bellows sleeve.

1. A filtering device having
an inlet for raw fluid coming under high operative pressure, an outlet for filtered fluid, a filter element disposed between the inlet and the outlet, said inlet being in fluid communication with an inlet chamber bounded by an inlet surface of said filter element, said inlet surface being prone to clogging by particles in the raw fluid,
a cleaning head for cleaning said inlet surface, comprising a basis and a nozzle mounted thereon, said nozzle having an orifice surrounded by a rim and connectable to a low-pressure outlet,
a driving mechanism with said cleaning head basis mounted thereon adapted to move said cleaning head basis to cause said nozzle to scan said inlet surface along scanned dimensions thereof, and clean it by means of a backwash flow passing through said filter element into said orifice under a cleaning pressure differential created by connecting said orifice to said low-pressure outlet, the distance between said cleaning head basis and said inlet surface varying during said scanning due to deviations of the inlet surface shape,
wherein,
the largest dimension of said orifice is at least an order of magnitude less than any scanned dimension of said inlet surface, and
said nozzle is movable with respect to said cleaning head basis and is urged to said inlet surface so as to maintain, during scanning, permanent contact between said rim and said inlet surface such that lateral flow therebetween from said inlet chamber directly into said orifice is essentially prevented despite said deviations.

2. The filtering device of claim 1, wherein said nozzle is mounted to said cleaning head basis by a moveable joint allowing perpendicular movement of the nozzle with respect to said inlet surface in order to maintain said permanent contact.

3. The filtering device of claim 2, wherein said joint comprises a biasing means urging said nozzle to said inlet surface to maintain said permanent contact.

4. The filtering device of claim 3, wherein said moveable joint and said biasing means allow said perpendicular movement of the nozzle within a first range of distance relative to said cleaning head basis, said filter element has deviations of said inlet surface within a second range of distance relative to said cleaning head basis, and said second range, during said scanning, is substantially within said first range.

5. The filtering device of claim 4, wherein the middle of said second range, during said scanning, is substantially in the middle of said first range.

6. The filtering device of claim 2, wherein said moveable joint is isolated from said suspended particles in the raw fluid and in the backwash flow.

7. The filtering device of claim 1, wherein said filtering element has the shape of a cylinder with said inlet chamber inside, and said driving mechanism provides the scanning of said inlet surface along a helical path coaxial with said cylinder.

8. A cleaning head for use in the filtering device of claim 1, wherein said nozzle is mounted to said cleaning head basis by a moveable joint allowing perpendicular movement of the nozzle with respect to said inlet surface in order to maintain said permanent contact.

9. The cleaning head of claim 8, wherein said moveable joint is a telescope joint.

10. The cleaning head of claim 9, wherein said joint comprises a biasing means urging said nozzle to said inlet surface to maintain said permanent contact.

11. The cleaning head of claim 10, wherein said biasing means is at least one cylindrical compression spring.

12. The cleaning head of claim 11, wherein said biasing means is a cylindrical compression spring coaxial with said telescope joint.

13. The cleaning head of claim 8, wherein said moveable joint is isolated from said suspended particles in the raw fluid and in the backwash flow.

14. The cleaning head of claim 13, wherein said moveable joint is a telescope joint isolated from said suspended particles by at least one sealing ring tightly and firmly mounted on said head basis and tightly sliding along said nozzle.

15. The cleaning head of claim 14, wherein said telescope joint further comprises at least one annular wiper mounted on said head basis so as to wipe a portion of the nozzle surface that slides past said sealing ring.

16. The cleaning head of claim 15, wherein said sealing ring is integral with said annular wiper.

17. The cleaning head of claim 13, wherein said moveable joint is isolated from said suspended particles by at least one deformable sleeve with one end tightly mounted on said head basis and with the other end tightly mounted on said nozzle.

18. The cleaning head of claim 8, wherein said rim has contact area less than 9 times the area of said orifice.

19. The cleaning head of claim 18, wherein said contact area is less than 4 times the area of said orifice.

20. The cleaning head of claim 8, wherein said rim is circular.

21. A cleaning head for cleaning a filter element in a filtering device having an inlet for raw fluid coming under high operative pressure and an outlet for filtered fluid, said filter element being disposed between the inlet and the outlet, said inlet being in fluid communication with an inlet chamber bounded by an inlet surface of said filter element, said inlet surface being prone to clogging by particles in the raw fluid,
said cleaning head comprising a basis and a nozzle movably mounted thereon, said nozzle having an orifice defined in a rim, said orifice being connectable to a low-pressure outlet, said cleaning head basis being mountable on a driving mechanism so that said nozzle can scan said inlet surface parallel thereto, and can clean said inlet surface by means of a backwash flow passing through said filter element into said orifice under a cleaning pressure differential created by connecting said orifice to said low-pressure outlet, wherein
the largest dimension of said orifice is at least an order of magnitude less than any dimension of said filter element along said inlet surface, and
said nozzle is movable to maintain, during scanning, permanent contact between said rim and said inlet surface so that lateral flow from said inlet chamber directly into said orifice is essentially prevented despite variations of distance between said cleaning head basis and said inlet surface during said scanning.

22. The cleaning head of claim 21, wherein said nozzle is mounted to said cleaning head basis by a joint allowing perpendicular movement of the nozzle with respect to said inlet surface in order to maintain said permanent contact.

23. The cleaning head of claim 22, wherein said joint comprises a biasing means urging said nozzle to said inlet surface to maintain said permanent contact.

24. The cleaning head of claim 23, wherein said moveable joint and said biasing means allow said perpendicular movement of the nozzle with a first range of distance relative to said cleaning head basis, said filter element has deviations of said inlet surface within a second range of distance relative to said cleaning head basis, and said second range, during said scanning, is substantially within said first range.

25. The cleaning head of claim 24, wherein the middle of said second range, during said scanning, is substantially in the middle of said first range.

26. The cleaning head of claim 23, wherein said moveable joint is a telescope joint.

27. The cleaning head of claim 26, wherein said biasing means is at least one cylindrical compression spring.

28. The cleaning head of claim 27, wherein said biasing means is a cylindrical compression spring coaxial with said telescope joint.

29. The cleaning head of claim 22 or 23, wherein said moveable joint is isolated from said suspended particles in the raw fluid and in the backwash flow.

30. The cleaning head of claim 29, wherein said moveable joint is a telescope joint connecting said nozzle to said head basis.

31. The cleaning head of claim 30, wherein said telescope joint is isolated by at least one sealing ring tightly and firmly mounted on said head basis and tightly sliding along said nozzle.

32. The cleaning head of claim 31, wherein said telescope joint further comprises at least one annular wiper mounted on said head basis so as to wipe a portion of the nozzle surface that slides past said sealing ring.

33. The cleaning head of claim 31, wherein said sealing ring is integral with said annular wiper.

34. The cleaning head of claim 29, wherein said telescope joint is isolated by at least one deformable sleeve with one end tightly mounted on said head basis and with the other end tightly mounted on said nozzle.

35. The cleaning head of claim 21, wherein said filtering element has the shape of a cylinder with said inlet chamber inside, and said driving mechanism provides the scanning of said inlet surface along a helical path coaxial with said cylinder.

36. The cleaning head of claim 21, wherein said rim has contact area less than 9 times the area of said orifice.

37. The cleaning head of claim 36, wherein said contact area is less than 4 times the area of said orifice.

38. The cleaning head of claim 36 or 37, wherein said rim is circular.
